(19) United States
(12) Patent Application Publication
(10) Pub. No.: US 2013/0258725 A1
(43) Pub. Date: Oct. 3, 2013

(54) Systems and Methods for Balancing UPS Source Currents During Unbalanced Load Transient Conditions

(71) Applicants: Silvio Colombi, Losone (CH); Yashomani Y. Kolhatkar, Secunderabad (IN); Marco Piemontesi, Biasca (CH); Malavalli Nanjundaswamy Lakshmi Prasad, Secunderabad (IN); Lauro Strozzi, Gordola (CH)

(72) Inventors: Silvio Colombi, Losone (CH); Yashomani Y. Kolhatkar, Secunderabad (IN); Marco Piemontesi, Biasca (CH); Malavalli Nanjundaswamy Lakshmi Prasad, Secunderabad (IN); Lauro Strozzi, Gordola (CH)

(73) Assignee: GENERAL ELECTRIC COMPANY, Schenectady, NY (US)

(21) Appl. No.: 13/434,841

(22) Filed: Mar. 29, 2012

(51) Int. Cl. H02M 1/12; H02M 5/458

(52) U.S. Cl. 363/37

(57) ABSTRACT

Systems and methods for balancing current from an AC source. The method includes determining a difference between a DC voltage output by a rectifier in an uninterruptible power supply (UPS) to a DC reference voltage. The method also includes determining an error between the DC voltage and the DC reference voltage based at least in part on the difference. After determining the error, the method includes filtering a second order harmonic from the error thereby generating a filtered error. The method may then include determining one or more switching signals for one or more switching components in the rectifier based at least in part on the filtered error and sending the switching signals to the rectifier.

### BACKGROUND OF THE INVENTION

The subject matter disclosed herein relates to an uninterruptible power supply (UPS), and more particularly, to improving the total harmonic distortion (THD) of source currents for a UPS during unbalanced load conditions.

A UPS system, such as a 3-phase stiff double conversion UPS system, may include a front-end rectifier, a direct current (DC) link with a capacitor and an energy storage device, and an inverter. The UPS system may use the front-end rectifier to convert source alternating current (AC) power into DC power that may be supplied to the DC link. The DC link may then provide the DC power to the capacitor, the energy storage device, and the inverter. The inverter may convert the DC power back to AC power, which may then be used to power a load device. If the AC power input into the front-end rectifier becomes unavailable, the energy storage device may act as a DC battery for the inverter, and the inverter may continue to provide AC power to the load device. In this manner, the UPS may provide uninterrupted power to load devices when its input AC power source becomes unavailable.

Under balanced load conditions, a constant power may be drawn from the input AC power source by the front-end rectifier, thereby providing for balanced three-phase source currents from the input AC power source. As a result, the output of the front-end rectifier is a steady state DC voltage. The steady state DC voltage may be input into a rectifier controller designed to control various switches in the front-end rectifier. The steady state DC voltage may cause the rectifier controller to send regular switching signals to the switches in the front-end rectifier such that the front-end rectifier evenly distributes the source currents within the front-end rectifier.

However, once the inverter load of the UPS becomes unbalanced, the power drawn from the DC bus voltage may fluctuate and the input AC source currents may no longer be constant. On the front-end rectifier side, the fluctuating DC bus voltage (i.e., ripple corrupted DC voltage) is input to the rectifier controller, which subsequently generates irregular firing signals for the front-end rectifier that results in unbalanced source currents and high total harmonic distortion (THD) in the source currents. Unfortunately, the high THD in the source current may have detrimental effects on the input AC source and the UPS.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system may include an uninterruptible power supply (UPS) coupled to an AC source. The UPS may include a rectifier having one or more switching components such that the rectifier may be configured to convert a first AC voltage received from the AC source into a DC voltage. The UPS may also include an inverter and a rectifier controller. The inverter may be configured to convert the DC voltage into a second AC voltage, while the rectifier controller may be configured to send one or more switching signals to the switching components on the rectifier. The rectifier controller include a module configured to determine a difference between a DC reference voltage and the DC voltage, a proportional-integral (PI) controller configured to receive the difference and determine an error between a DC reference voltage and the DC voltage, and a notch filter configured to receive the error, filter a second order harmonic from the error, and generate a reference current. The reference current may be used, at least in part, to determine the switching signals.

In a second embodiment, a method for balancing current from an AC source may include determining a difference between a DC voltage output by a rectifier in an uninterruptible power supply (UPS) to a DC reference voltage. The method may also include determining an error between the DC voltage and the DC reference voltage based at least in part on the difference. After determining the error, the method may include filtering a second order harmonic from the error thereby generating a filtered error and determining one or more switching signals for one or more switching components in the rectifier based at least in part on the filtered error. The method may then include sending the switching signals to the rectifier.

In a third embodiment, a system may include a UPS coupled to an AC source such that the UPS may include a rectifier that may have one or more switching components. The rectifier may be configured to convert a first AC voltage received from the AC source into a DC voltage. The UPS may also include an inverter and a rectifier controller. The inverter may be configured to convert the DC voltage into a second AC voltage. The rectifier controller may be configured to determine an error between the DC voltage and a DC reference voltage, filter a second order harmonic from the error to generate a filtered error, determine one or more switching signals for the switching components based at least in part on the filtered error, and send the switching signals to the rectifier.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a simplified block diagram of an uninterruptible power supply (UPS), in accordance with an embodiment;

FIG. 2 is a simplified block diagram of a rectifier controller with a notch filter for a UPS, in accordance with an embodiment;

FIG. 3 is graph of three phase source currents during an unbalanced load for a UPS without using a notch filter in a rectifier controller for the UPS, in accordance with an embodiment;

FIG. 4 is a graph of three phase source currents for a UPS with a notch filter placed before a proportional-integral (PI) controller in a voltage controller of a rectifier controller for the UPS, in accordance with an embodiment;

FIG. 5 is a graph of three phase source currents for a UPS with a notch filter placed after a proportional-integral (PI) controller in a voltage controller of a rectifier controller for the UPS, in accordance with an embodiment.

### DETAILED DESCRIPTION OF THE INVENTION

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

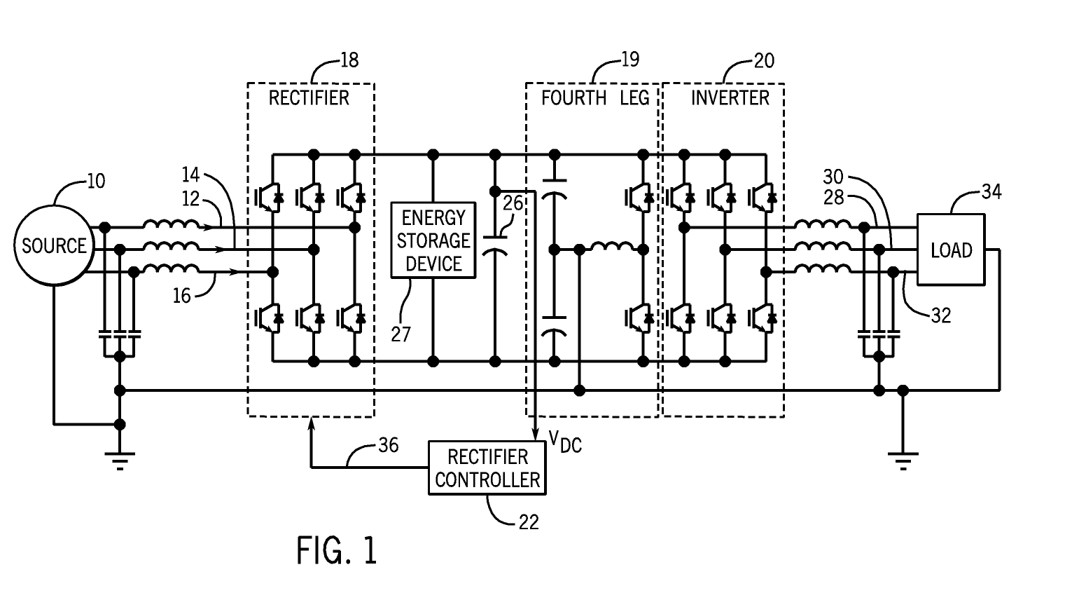

Referring to FIG. 1, a block diagram of an uninterrupted power supply (UPS) 8 is illustrated as an embodiment. The UPS 8 may be coupled to an input alternating current (AC) source 10 that supplies 3-phase power on lines 12, 14, and 16. In one embodiment, the UPS 8 may include a rectifier 18, a fourth leg 19, an inverter 20, and a rectifier controller 22. The rectifier controller 22 may control the operation of the rectifier 18 such that the rectifier 18 provides some direct current (DC) power to the inverter 20. The rectifier 18 may convert the three-phase AC power from the input AC source 10 on lines 12, 14, and 16 into DC power on DC bus 24. A DC capacitor 26 coupled between positive and negative terminals of the DC bus 24 may filter some residual AC components of the DC power on the DC bus 24. In addition to the DC capacitor 26, the fourth leg 19 may be used to stabilize the UPS 8 if the load 32 becomes unbalanced. In one embodiment, an energy storage device 27 may be coupled between the positive and negative terminals of the DC bus 24 to store DC power. As such, DC power may be provided to the inverter 20 via the rectifier 18 and the fourth leg 19 when the input AC source 10 is on or via the energy storage device 27 when the input AC source 10 is off. The inverter 20 may subsequently convert the DC power of the DC bus 24 into three-phase AC power on lines 28, 30, and 32. The three-phase AC power may then be output to a load 34.

As mentioned above, the rectifier controller 22 may control the operation of the rectifier 18 using a processor operably coupled to memory and/or storage. The processor and/or other data processing circuitry may carry out instructions stored on any suitable article of manufacture having one or more tangible, machine-readable media at least collectively storing such instructions. The memory and/or storage may represent such articles of manufacture. Among other things, the memory and/or the storage may represent random-access memory, read-only memory, rewriteable memory, a hard drive, or optical discs.

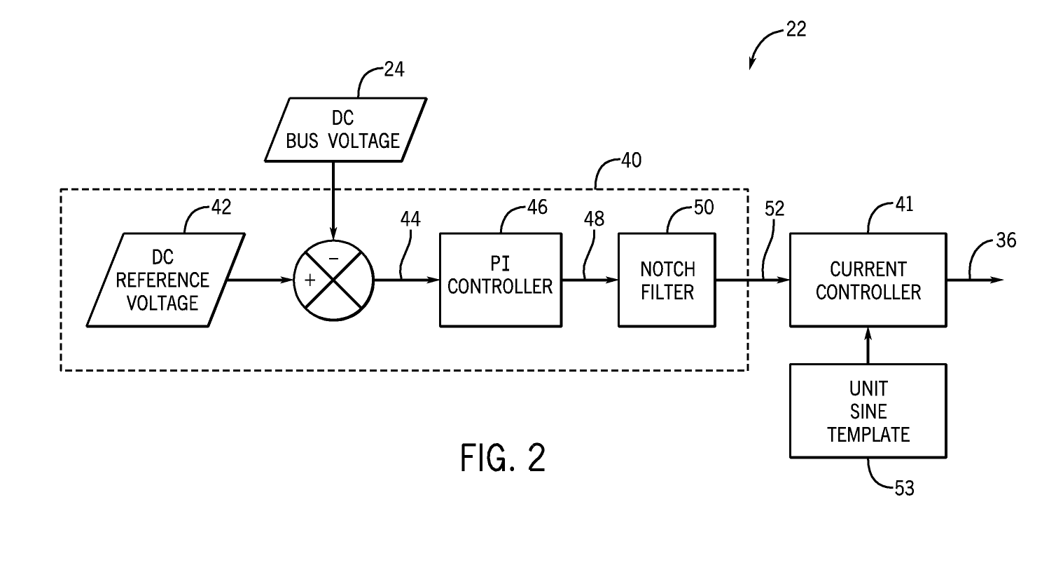

In one embodiment, the rectifier controller 22 may control how the rectifier 18 converts the AC power of the input AC source 10 into DC power for the DC bus 24 by sending switching signals 36 to a number of switches, such as thyristors, in the rectifier 18. In this manner, the rectifier controller 22 may control the amount of current passing through each of its legs, which may control the amount of current drawn from each phase of the AC input source 10 on lines 12, 14, and 16. The rectifier controller 22 is described in greater detail with reference to FIG. 2.

As mentioned above, under normal operating conditions (i.e., balanced loads), if the DC bus voltage 24 is constant, the rectifier controller 22 may send switching signals 36 to the rectifier 18 at regular intervals such that each leg of the rectifier 18 may draw an equal amount of current from the input AC source 10, thereby providing for balanced three-phase input currents. However, if the load 34 on the inverter 20 becomes unbalanced, the rectifier controller 22 may send switching signals 36 to the rectifier 18 at irregular intervals such that each leg of the rectifier 18 may draw an unequal amount of current from the input AC source 10, thereby providing for unbalanced three-phase input currents. The effect of load balancing by the inverter 20 is illustrated in Equations 1-3 below.

iᵢₙᵥ=S_{A}i_{load}_{_{—}}_{A}+S_{B}i_{load}_{_{—}}_{B}+S_{C}i_{load}_{_{—}}_{C} Equation 1

In Equation 1, the inverter input current (iᵢₙᵥ) is based on when switching functions (i.e., S_{A}, S_{B} and S_{C}) for top switches in the inverter 20. When the top switch of a leg i is on, Sᵢ=1, otherwise, Sᵢ=0, where i stands for phase {A, B, C}. The spectra of these switching functions can be expanded assuming purely sinusoidal phase currents as illustrated in Equation 2 below.

iᵢₙᵥ(t)=Σₖ₌₁^{∞}Aₖ sin kωt*i_{load}_{_{—}}_{A} sin(ωt+Ø_{A})+Σₖ₌₁^{∞}Aₖ sin(kωt−120°)*i_{load}_{_{—}}_{B} sin(ωt+Ø_{B})+Σₖ₌₁^{∞}Aₖ sin(kωt−240°)*i_{load}_{_{—}}_{C} sin(ωt+Ø_{C}) Equation 2

In Equation 2, Aₖ is the magnitude of the k^{th} order component and Aₖ=0 for all even k. After performing a trigonometric transform, Equation 3 may be obtained.

$${i}_{inv} ( t ) = \frac{{i}_{outA}}{2} {\sum }_{k = 1}^{∞} {A}_{k} \{ \begin{matrix}cos [ ( k - 1 ) * ω t - {∅}_{A} ] - \\ cos [ ( k + 1 ) * ω t + {∅}_{A} ]\end{matrix} \} + \frac{{i}_{outB}}{2} {\sum }_{k = 1}^{∞} {A}_{k} \{ \begin{matrix}cos [ \begin{matrix}( k - 1 ) * ω t - ( k - 1 ) * \\ 120 ° - {∅}_{B}\end{matrix} ] - \\ cos [ \begin{matrix}( k + 1 ) * ω t - ( k + 1 ) * \\ 120 ° + {∅}_{B}\end{matrix} ]\end{matrix} \} + \frac{{i}_{outC}}{2} {\sum }_{k = 1}^{∞} {A}_{k} \{ \begin{matrix}cos [ \begin{matrix}( k - 1 ) * ω t - ( k - 1 ) * \\ 240 ° - {∅}_{C}\end{matrix} ] - \\ cos [ \begin{matrix}( k + 1 ) * ω t - ( k + 1 ) * \\ 240 ° + {∅}_{C}\end{matrix} ]\end{matrix} \} = {i}_{load 0} + {\sum }_{n = 1}^{∞} {i}_{loadn} sin n ( ω t + {∅}_{C} ) \qquad Equation 3$$

In Equation 3, i_{load0} is the DC component of the inverter input current and i_{loadn} is the magnitude of n^{th} order component of the DC component. By analyzing Equation 3, it is apparent that i_{loadA}=i_{loadB}=i_{loadC} and Ø_{A}=Ø_{B}=Ø_{C} hold and i_{loadn}=0 for n>0 if the three phase load currents on lines 28, 30, and 32 are balanced. Otherwise, if the three phase load currents are unbalanced, an AC component may exist in the DC input current, which may cause a ripple. It can be mathematically proven that the A₁ component only contributes i_{load0} and i_{load2}, which is the origin of a second order harmonic in the DC input current. This second order harmonic is input into the inverter 20 current which may cause the voltage of the capacitor 26 to fluctuate. As a result, the DC voltage 24 input into the rectifier controller 22 may also fluctuate which may cause the rectifier controller 22 to send switching signals 36 at irregular intervals, thereby creating a second order harmonic component in the output current of the rectifier 18. Consequently, the second order harmonic in the output current of the rectifier 18 may cause the input source currents (12, 14, and 16) to also become unbalanced.

Keeping the foregoing in mind, FIG. 2 illustrates a block diagram of the rectifier controller 22. The rectifier controller 22 includes a voltage controller 40 and a current controller 41. As indicated in FIG. 2, the DC bus voltage 24 is input into the voltage controller 40 and compared to a DC reference voltage 42. The DC reference voltage 42 may be a constant value that represents an expected value for the DC bus voltage 24. In one embodiment, the DC bus voltage 24 may be subtracted from the DC reference voltage 42, and the difference between the two voltages (i.e., difference 44) may be input into a proportional-integral (PI) controller 46 configured to determine an error 48 between the two voltages. Although FIG. 2 has been described with the PI controller 46, in some embodiments, other types of control loop mechanisms, such as a derivative controller, an integral controller, a digital controller, and the like, may be used to determine the error 48 between the two voltages.

Under normal operating conditions (i.e., balanced loads), the DC bus voltage 24 is constant and, consequently, the error 48 remains constant. Generally, the error 48 may be directly input to the current controller 41 as a reference current for determining switching signals 36. Since the error 48 is constant for normal operating conditions, the reference current input to the current controller 41 is also constant, which causes the current controller 41 to generate regular switching signals 36. However, if the load 34 on the inverter 20 becomes unbalanced, the DC bus voltage 24 may fluctuate due to the second order harmonic in the DC current input. Consequently, the difference 44 and the error 48 may fluctuate as the DC bus voltage 24 fluctuates.

By directly inputting the fluctuating error 48 into the current controller 41 as the reference current, the source currents on lines 12, 14, and 16 may become unbalanced and have a high total harmonic distortion (THD), which may damage the UPS 8. For instance, the fluctuating error 48 could potentially cause the current controller 41 to generate irregular switching signals 36 for the rectifier 18 due to its high bandwidth. That is, since the current controller 41 has a high bandwidth, it is capable of performing fast current tracking and processing a large portion of data that corresponds to the fluctuating error 48. As the error 48 fluctuates, the current controller 41 may generate irregular switching signals 36 based on numerous irregular error values of the fluctuating error 48. The irregular switching signals 36 may cause the rectifier 18 to draw unbalanced input source currents on lines 12, 14, and 16, which may cause a high total harmonic distortion (THD) in the input source currents.

The unbalanced source currents and high THD issues, however, may be avoided by placing a notch filter 50 between the PI controller 46 and the current controller 41. That is, instead of directly inputting the error 48 into the current controller 41 as described above, the error 48 may be input into a notch filter 50 prior to being sent to the current controller 41 to improve the stability and transient response of the rectifier 18 during unbalanced load conditions. The notch filter 50 may be configured to remove the second order harmonic component from the error 48. In one embodiment, the notch filter 50 may be a deep digital domain notch filter designed with consideration to the stability margins of the voltage controller 40. In other words, the notch filter 50 may be designed to account for the dominant poles of the PI controller 46 to ensure that the voltage controller 40 remains stable during operation. After filtering the second order harmonic component from the error 48, the notch filter 50 produces a reference current 52 that may be used by the current controller 41 to determine the switching signals 36. The reference current 52 may represent an amount of current drawn from the input AC source 10.

In one embodiment, the current controller 41 may multiply the reference current 52 with a unit sine template 53 that is in phase with the source voltage for each input phase. The product of the reference current 52 and the unit sine template 53 may represent a reference current for each phase of the input source 10 that corresponds to an amount of current drawn from each phase of the input AC source 10. The current controller 41 may then compare each reference current for each phase of the input AC source 10 to the actual current on each phase of the input AC source 10 to determine a reference voltage for each phase of the input AC source 10. The current controller 41 may then compare the reference voltage for each phase of the input AC source 10 to an actual voltage in a source capacitor for each phase of the input AC source 10 and generate firing pulses with different magnitudes in times with some carrier frequency, which may be used as the switching signals 36 used to operate the switches in the rectifier 18. Since the current controller 41 generates the switching signals 36 based at least in part on the reference current 52 output by the notch filter 50, the switching signals 36 will not be affected by the second order harmonic in the DC bus voltage 24.

As a result, by removing the second order harmonic component in the reference current 52, the notch filter 50 improves the THD in the source input currents (12, 14, and 16) of the UPS 8 for unbalanced load conditions. Further, the notch filter aids the UPS 8 in achieving better dynamic response of input current wave shaping and avoids various system instability issues.

Additionally, by using the notch filter 50 in the rectifier controller 22, the UPS 8 remains highly effective under unbalanced load conditions and during sudden load disturbances without requiring any additional complex control algorithms or circuitry. Conversely, without using the notch filter 50 in the rectifier controller 22, the capacitor 26 would need to be increased in order to reduce the ripple in the capacitor voltage that causes the unbalanced source currents. Unfortunately, this approach may prove to be impractical and not very cost-effective. In one embodiment, the use of the notch filter 50 in the rectifier controller 34 may become more relevant for transformer-less UPS platforms where an output Delta-Star-zig-zag transformer is absent to prevent the considerable amount of unbalanced current entering into DC bus after the rectifier 18. Although FIG. 2 has been described using the notch filter 50, it should noted that the rectifier controller 22 is not limited to using the notch filter 50 may use any type of filter to remove the second order harmonic component from the error 48.

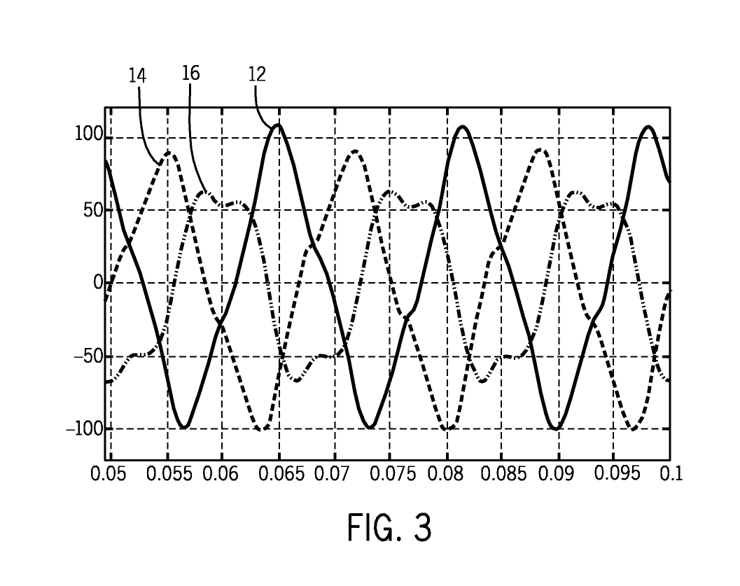

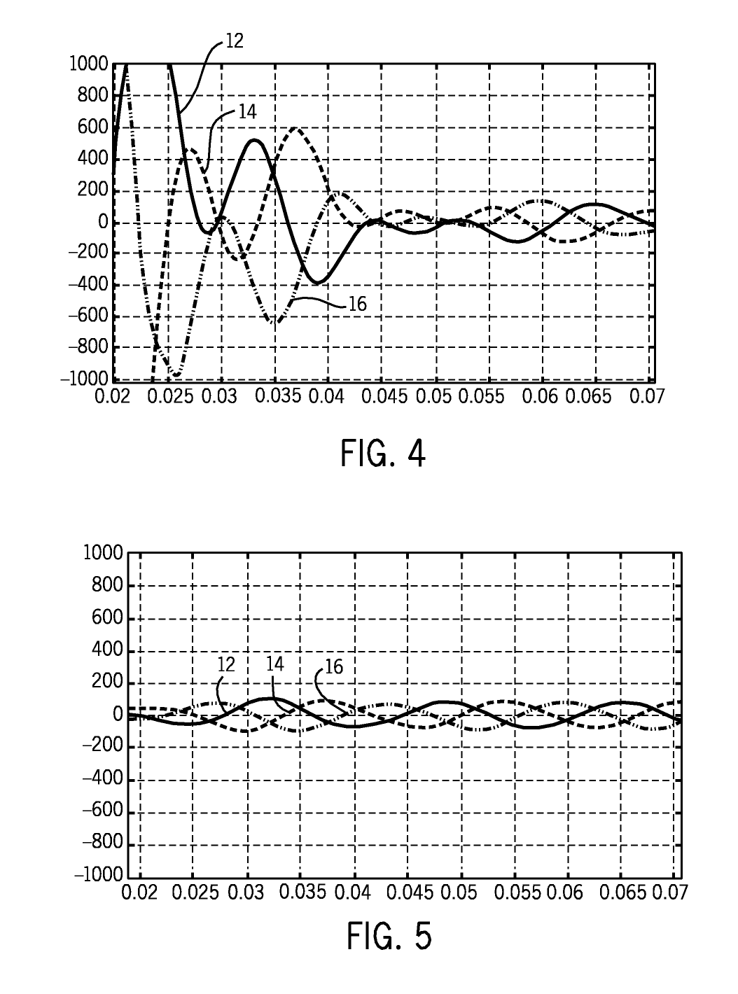

To further illustrate how the notch filter 50 helps balance source currents, FIG. 3 illustrates three-phase source currents for the UPS 8 while coupled to an unbalanced load. The UPS 8 of FIG. 3 does not employ a notch filter in the rectifier controller 22 as described above. As seen in FIG. 3, the second order harmonics cause the source currents to become unbalanced with respect to each other. In general, notch filters are coupled directly to the DC bus voltage 24 in rectifier controllers to DC bus voltage 24. However, as illustrated in FIG. 4, source currents may reach 1000 A in unstable systems. This high current may cause saturation in the PI controller 46, which may then destabilize the UPS 8.

By placing the notch filter 50 after the PI controller 46, the notch filter 50 may be configured to account for the stability of the PI controller 46 in addition to filtering the second order harmonic from the error 48. In this manner, the source currents may be limited such that they do not cause damage to the input AC source 10 or the UPS 8 and provide for a stable UPS 8. FIG. 5 illustrates the effect of placing the notch filter 50 after the PI controller 46 for source currents during unbalanced load conditions. As seen in FIG. 5, the three phase source currents are balanced within one cycle and remain below 150 amps.

Technical effects of the present disclosure include, among other things, an improved THD in the source input currents of the UPS 8 for unbalanced load conditions. Further, the UPS 8 may achieve better dynamic response of input current wave shaping and avoid various system instability issues.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an uninterruptible power supply (UPS), comprising:
a rectifier having one or more switching components, wherein the rectifier is configured to convert a first AC voltage received from an AC source into a DC voltage;
an inverter configured to convert the DC voltage into a second AC voltage; and
a rectifier controller configured to send one or more switching signals to the switching components, wherein the rectifier controller comprises:
a component configured to determine a difference between a DC reference voltage and the DC voltage;
a controller configured to receive the difference and determine an error between a DC reference voltage and the DC voltage; and
a filter configured to:
receive the error from the controller;
filter a second order harmonic from the error; and
generate a reference current, wherein the switching signals are based at least in part by the reference current.

2. The system of claim 1, wherein the inverter is coupled to an unbalanced load.

3. The system of claim 2, wherein the DC voltage comprises the second order harmonic.

4. The system of claim 2, wherein the rectifier is configured to balance one or more currents output by the AC source within one cycle.

5. The system of claim 2, wherein the filter is configured to decrease a total harmonic distortion in one or more currents output by the AC source.

6. The system of claim 1, wherein the filter is configured to maintain one or more stability margins of the rectifier controller.

7. The system of claim 1, wherein the filter is configured to prevent the controller from becoming saturated.

8. The system of claim 1, wherein the filter comprises a notch filter.

9. The system of claim 8, wherein the notch filter comprises a deep digital domain notch filter.

10. The system of claim 1, wherein the controller comprises a proportional-integral (PI) controller.

11. The system of claim 10, wherein the filter is configured to account for one or more dominant poles of the PI controller.

12. The system of claim 1, wherein the UPS is a transformer-less UPS.

13. A method for balancing current from an AC source, comprising:
determining a difference between a DC voltage output by a rectifier in an uninterruptible power supply (UPS) to a DC reference voltage;
determining an error between the DC voltage and the DC reference voltage based at least in part on the difference;
filtering a second order harmonic from the error thereby generating a filtered error;
determining one or more switching signals for one or more switching components in the rectifier based at least in part on the filtered error; and
sending the switching signals to the rectifier.

14. The method of claim 13, wherein determining the error between the DC voltage and the DC reference voltage comprises sending the error to a proportional-integral (PI) controller.

15. The method of claim 14, wherein the second order harmonic is filtered with respect to one or more dominant poles of the PI controller.

16. The method of claim 13, wherein filtering the second order harmonic from the error comprises sending the error to a notch filter.

17. An article of manufacture comprising:
one or more tangible, machine-readable media at least collectively comprising machine-executable instructions, the instructions configured to:
determine an error between a DC voltage output by a rectifier in an uninterruptible power supply (UPS) and a DC reference voltage;
filter a second order harmonic from the error to generate a filtered error;
determine one or more switching signals for one or more switching components in the rectifier based at least in part on the filtered error; and
send the switching signals to the rectifier.

18. The article of manufacture of claim 17, wherein the error is determined using proportional-integral (PI) logic.

19. The article of manufacture of claim 17, wherein the switching signals are configured to balance one or more currents input into the rectifier.

20. The article of manufacture of claim 17, wherein the second order harmonic is filtered by applying a deep digital domain notch filter to the error.
